(19) United States
(12) Patent Application Publication
(10) Pub. No.: US 2010/0129010 A1
(43) Pub. Date: May 27, 2010

(54) TWO WAY SLIDING APPARATUS

(76) Inventor: Won-Hyung Jo, Seoul (KR)

Correspondence Address: LADAS & PARRY LLP, 26 WEST 61ST STREET, NEW YORK, NY, 10023, US

(21) Appl. No.: 12/516,064

(22) PCT Filed: Nov. 22, 2007
(86) PCT No.: PCT/KR2007/005895

§ 371 Date: Dec. 7, 2009

(30) Foreign Application Priority Data
Nov. 22, 2006 (KR) 10-2006-0115816

(51) Int. Cl. F16C 29/02

(52) U.S. Cl. 384/10

(57) ABSTRACT

The present invention relates to a two way sliding device for a portable terminal in which a cover is slid with respect to a main body. The two way sliding device comprises a flat plate-shaped stationary stage fixed to the main body, the stationary stage having X-axial moving guide portions formed at upper and lower sides thereof in the vertical direction; an X-axis moving stage having X-axis sliding portions provided at upper and lower sides thereof in the horizontal direction to be coupled with the X-axial moving guide portions and moved in the horizontal direction, the X-axis moving stage having Y-axial moving guide portions provided at both lateral sides thereof in the vertical direction, the X-axis moving stage having an opening formed at a center thereof; a Y-axis moving stage fixed to the cover, the Y-axis moving stage having Y-axis sliding portions formed at both lateral sides thereof to be coupled with the Y-axial moving guide portion and moved within the opening in the vertical direction; and an elastic member having an end coupled with the stationary stage and the other end coupled with the Y-axis moving stage, thereby being rotated 360 degrees within a range of the opening when the slide of the X-axis moving stage in the horizontal direction and the slide of the Y-axis moving stage in the vertical direction cooperate with each other.

### TECHNICAL FIELD

The present invention relates to a portable terminal, and more particularly, to a two way sliding device for a portable terminal, which is slim and enables a cover to slide freely in vertical and horizontal directions.

### BACKGROUND ART

In general, a portable information device (hereinafter, referred to as “terminal”) such as a cellular phone, an electronic dictionary, a notebook computer, a portable multimedia player (PMP) and the like is a device for wireless communication such as a conversation or a data transmission. In the terminal, a cover provided with a display liquid crystal is coupled to a main body provided with a key pad to be openable and closable.

According to an external appearance or opening/closing structure of a cover with respect to a main body, terminals may be classified into a bar type terminal, a flip type terminal, a folder type terminal, a slide type terminal, and the like.

In the above various type terminals, a slide type terminal can be conveniently carried since the length thereof can be reduced, and can be provided with a larger liquid crystal display. In addition, as compared with a folder type terminal, the slide type terminal is advantageous in that the opening/closing operation is performed more easily, whereby the slide type terminal has been popularized over recent.

Meanwhile, in a conventional terminal, a cover can be slid only in one axial direction. In recent, however, a terminal in which a cover can be slid in two axial (X-axial and Y-axial) directions has been provided.

For example, Korean Utility Model Registration No. 0421654 discloses a dual slide for a game and phone terminal capable of sliding operation in the X- and Y-axial directions perpendicular to each other. However, such a sliding device should have a three story stage structure and need at least two elastic members for each stage to slide.

Accordingly, such a sliding device should be designed to be 1.5 to 3 times as thick as a general sliding device, so that an entire thickness of the terminal is increased and the durability of the terminal is lowered due to unstable movement caused by an increase of vertical displacement difference between the stages. In addition, such a terminal is disadvantageous in that the slide stage should be necessarily slid in any one direction (generally, upward direction) in order to move the slide stage in the horizontal direction.

The aforementioned sliding device runs counter to a slim sized terminal having a thickness of several millimeters, which is one of the most features of the recent terminal market, and deteriorates customer's propensity to purchase.

### DISCLOSURE OF INVENTION

### Technical Problem

The present invention is conceived to solve the aforementioned problems. An object of the present invention is to provide a two way sliding device for a portable terminal, in which guide portions of three (3) kinds of stages are placed on the same plane without a difference in vertical phase displacement to thereby minimize the thickness of a terminal and only one elastic member is utilized to make a safe and precise sliding possible.

### Technical Solution

According to the present invention for achieving the objects, there is provided a two way sliding device for a potable terminal in which a cover is slid with respect to a main body. The two way sliding device comprises a flat plate-shaped stationary stage fixed to the main body, the stationary stage having X-axial moving guide portions formed at upper and lower sides thereof in the vertical direction; an X-axis moving stage having X-axis sliding portions provided at upper and lower sides thereof in the horizontal direction to be coupled with the X-axial moving guide portions and moved in the horizontal direction, the X-axis moving stage having Y-axial moving guide portions provided at both lateral sides thereof in the vertical direction, the X-axis moving stage having an opening formed at a center thereof; a Y-axis moving stage fixed to the cover, the Y-axis moving stage having Y-axis sliding portions formed at both lateral sides thereof to be coupled with the Y-axial moving guide portion and moved within the opening in the vertical direction; and an elastic member having an end coupled with the stationary stage and the other end coupled with the Y-axis moving stage, thereby being rotated 360 degrees within a range of the opening when the slide of the X-axis moving stage in the horizontal direction and the slide of the Y-axis moving stage in the vertical direction cooperate with each other.

### ADVANTAGEOUS EFFECTS

As described above, a two way sliding device for a portable terminal according to the present invention has advantages as follows.

First, stationary, X-axis moving and Y-axis moving stages are provided in a one story structure and two way sliding operation can be achieved in a one story structure using an elastic member, so that the portable terminal can be made more slim to satisfy the customer's propensity to purchase.

Second, since a two way sliding structure can be obtained by utilizing an elastic member, a structure of the sliding device can be more simplified than that of a conventional sliding device. Due to the above structure, it is possible to reduce the number of parts necessary for assembling the sliding device, so that the manufacturing cost and the assembling time can be reduced.

Third, an axial rotation of 360 degrees of the elastic member placed between the stationary stage and the Y-axis moving stage causes sliding operation in the X- or Y-axial direction to be performed freely according to the user's intention.

### BRIEF DESCRIPTION OF THE DRAWINGS

FIG. 1 is a perspective view showing a two way sliding device according to a first embodiment of the present invention;

FIG. 2 is an exploded perspective view of the two way sliding device of FIG. 1;

FIG. 3 is a sectional view taken along line III-III in FIG. 1;

FIG. 4 is a sectional view taken along line IV-IV in FIG. 1;

FIG. 5 is a plan view showing the operation of the two way sliding device of FIG. 1;

FIG. 6 is a perspective view showing a two way sliding device according to a second embodiment of the present invention;

FIG. 7 is an exploded perspective view of the two way sliding device of FIG. 6;

FIG. 8 is an exploded perspective view showing an elastic member of FIG. 6;

FIG. 9 is a plan view showing the operation of the two way sliding device of FIG. 6;

FIG. 10 is a perspective view showing a two way sliding device according to a third embodiment of the present invention;

FIG. 11 is an exploded perspective view of the two way sliding device of FIG. 10;

FIG. 12 is a sectional view taken along line XII-XII in FIG. 10;

FIG. 13 is a sectional view taken along line XIII-XIII in FIG. 10;

FIG. 14 is a plan view showing the operation of the two way sliding device of FIG. 10; and

FIGS. 15 and 16 are perspective views showing modifications of the two way sliding device of the present invention.

### EXPLANATION OF REFERENCE NUMERALS FOR MAJOR PORTIONS SHOWN IN DRAWINGS

110: Stationary stage 111: X-axial moving guide portion
120: X-axis moving stage 121: X-axis sliding portion
122: Y-axial moving guide portion 130: Y-axis moving stage
131: Y-axis sliding portion 140: Elastic member
141: First hinge shaft 142: Second hinge shaft
143: Elastic spring

### BEST MODE FOR CARRYING OUT THE INVENTION

Hereinafter, a two way sliding device for a portable terminal according to the present invention will be described with reference to accompanying drawings.

A two way sliding device S according to the present invention is disposed between a main body and a cover of a portable terminal (not shown) and is configured such that the two way sliding device is slid in the X- and Y-axial directions on the main body to the permissible extent that the cover can slide.

In this description, at this time, the most general cellular phone is described and illustrated as the portable terminal. Besides the cellular phone, however, the two way sliding device S according to the present invention can be applied to a variety of articles such as an electronic dictionary, a notebook computer, a PMP, and the like.

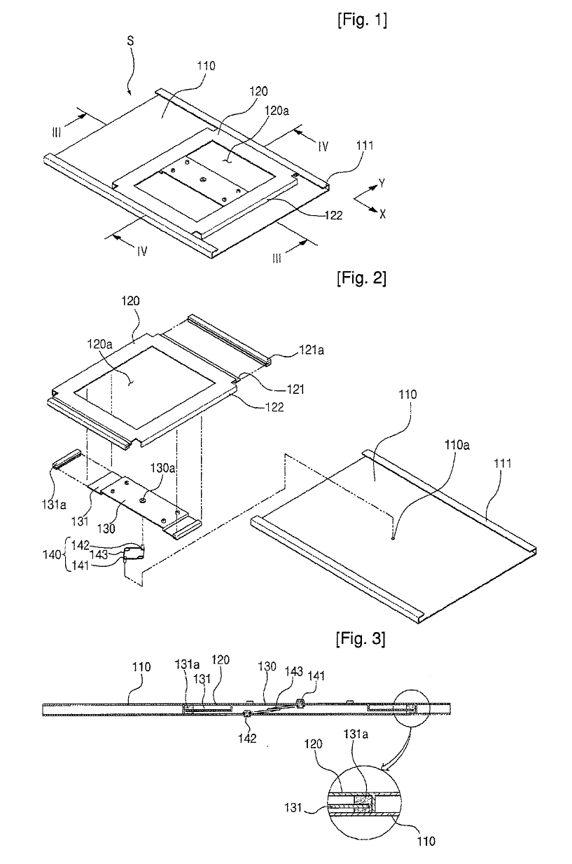

A two way sliding device S according to a first embodiment of the present invention is illustrated in FIGS. 1 to 5.

The two way sliding device S according to the first embodiment comprises a stationary stage 110 fixed to a main body provided with a key pad and the like; an X-axis moving stage 120 coupled to the stationary stage 110 and slid in the horizontal direction; and a Y-axis moving stage 130 fixed to a cover provided with a liquid crystal display and slid in the vertical direction.

The stationary stage 110 is formed in the shape of an approximately rectangular flat plate, and X-axial moving guide portions 111 are respectively provided at upper and lower sides of the stationary stage 110 to extend in the X-axial direction. Each of the X-axial moving guide portions 111 defines a “□”-shaped guide groove, which is bent upward and then extends inward to face itself.

The X-axis moving stage 120 is slid on the stationary stage 110 in the X-axial direction. Like the stationary stage 110, the X-axis moving stage is formed in the shape of a rectangle, and X-axis sliding portions 121, which are coupled with the X-axial moving guide portions 111 for the X-axis moving stage to be slid in the X-axial direction, are respectively provided at upper and lower sides of the X-axis moving stage. Each of the X-axis sliding portions 121 defines a “□”-shaped sliding rail, which is bent downward in an opposite direction to the X-axis moving stage 120 and then extends outward. A “□”-shaped guide member 121a is coupled to and wraps an end of each sliding rail to prevent the sliding rail from directly contacting with the guide groove and being worn away. It is preferable that this guide member 121a be made of a material having a predetermined elasticity such as crude rubber or synthetic resin by which the friction can be reduced.

In addition, Y-axial moving guide portions 122 are formed at both lateral sides of the X-axis moving stage 120 so that the Y-axis moving stage 130 is coupled with the Y-axial moving guide portions to be movable. Each of the Y-axial moving guide portions 122 has a “□” shape, which is simply bent downward from each of both ends of the X-axis moving stage 120. At this time, the Y-axial moving guide portion 122 is not formed into the “□”-shaped guide groove but into the simple “□” shaped bent, so that it is possible to contribute to the slimness of the sliding device. That is, due to the “0” shaped Y-axial moving guide portion 122, the Y-axis moving stage 130 can be slid stably between the upper surface of the stationary stage 110 and the low surface of the X-axis moving stage 120 without escaping.

In the meantime, it is preferable that an opening 120a be formed at a central portion of the X-axis moving stage 120 so that a single elastic member 140 to be described later is directly connected to the Y-axis moving stage 130 through the opening and the Y-axis moving stage 130 is provided with a sufficient radius of rotation.

The Y-axis moving stage 130 is to move the cover on the X-axis moving stage 120 in the Y-axial direction. Y-axis sliding portions 131 are provided at both lateral sides of the Y-axis moving stage 130 so that the Y-axis sliding portions are inserted into and coupled with the Y-axial moving guide portions 122 of the X-axis moving stage 120.

At this time, a sufficient space should be secured between the stationary stage 110 and the Y-axis moving stage 130 so that the elastic member 140 is coupled thereto and they operate smoothly. Accordingly, each of the Y-axis sliding portions 131 has a “□”-shape bent downward from the Y-axis moving stage 130 and is interposed between the stationary stage 110 and the X-axis moving stage 120, so that the Y-axis moving stage 130 has a “cap” shape having an upward convex center portion. At this time, considering the entire thickness of the sliding device, the Y-axis moving stage 130 should be formed so that an upper surface thereof does not protrude above the X-axis moving stage 120.

In addition, it is preferable that a guide member 131a made of crude rubber or synthetic resin as described above be coupled with and wraps an end of each Y-axis sliding portion 131.

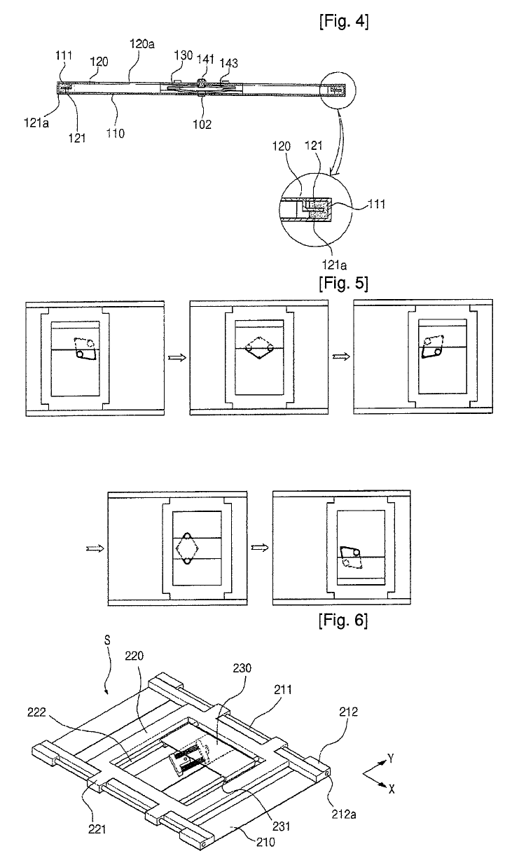

As described above, the “□”-shaped X-axis sliding portion 121 of the X-axis moving stage 120 is inserted into the “□”-shaped X-axial moving guide portion 111 of the stationary stage 110. The Y-axis sliding portion 131 of the Y-axis moving stage 130 is inserted between the “□” shaped Y-axial moving guide portion 122 of the X-axis moving stage 120 and the stationary stage 110. The Y-axis moving stage 130 is movable in the opening 120a of the X-axis moving stage 120. Thus, the sliding device has a one story structure as shown in FIGS. 3 and 4, whereby the thickness of the sliding device can be minimized.

In FIG. 2, unexplained reference numerals 110a and 130a designate hinge holes through which hinge shafts pass.

In the meantime, the stationary stage 110 and the Y-axis moving stage 130 are elastically interconnected to each other through the elastic member 140. The elastic member 140 provides elastic force according to a change in movement of the Y-axis moving stage 130 to enable the X-axis moving stage 120 or the Y-axis moving stage 130 to be slid semi-automatically.

Considering the entire thickness of the sliding device, the elastic member 140 is interposed between the stationary stage 110 and the Y-axis moving stage 130, that is, in the opening 120a of the X-axis moving stage 120, wherein one end of the elastic member is coupled to the stationary stage 110 and the other end is coupled to the center of the Y-axis moving stage 130, thereby providing the elastic force at the critical point or more when the moving stages are slid in the X-axial direction and the Y-axial direction with respect to the stationary stage 110.

That is, the elastic member 140 includes a first hinge axis 141 rotatably coupled to the center of the stationary stage 110; a second hinge shaft 142 rotatably coupled to the center of the Y-axis moving stage 130; and a compression spring 143 having one end coupled with the first hinge shaft 141 an the other end coupled with the second hinge shaft 142.

Unlike an elastic member used in a conventional slide type terminal in which only one of the X-axial linear movement and the Y-axial linear movement is performed, the X-axial linear movement and the Y-axial linear movement can be performed by only one elastic member 140 as described above. The above configuration can reduce the number of parts and a weight of the two way sliding device to save the manufacturing cost, and a defect rate of the device can be reduced due to the minimization of the number of parts to improve the durability of the sliding device.

As described above, after user's sliding operation in a certain direction, one end of the elastic member 140 is coupled to the center of the stationary stage 110 and the other end is coupled to the center of a lower surface of the X-axis moving stage 120 to provide the force for axial rotation of 360 degrees.

Here, a radius of 360 degree axial rotation of the X-axis moving stage 120 means a radius of rotation of the Y-axis moving stage 130 rotating clockwise or counter-clockwise about the first hinge shaft 141 fixed to the upper surface of the stationary stage 110 for the XY movement caused by coupling the X-axis moving stage 120 and the Y-axis moving stage 130. The first hinge shaft 141 is located at the point on the upper surface of the stationary stage 110 at which an intermediate point of moving width of the Y-axis moving stage 130 meets an intermediate point of moving width of the X-axis moving stage 120.

At this time, it is preferable that a distance (hereinafter, referred to as “radius of rotation”) between the lower surface of the Y-axis moving stage 130 and the fixing point of the elastic member 140 positioned on the upper surface of the stationary stage 110 do not exceed a half (hereinafter, referred to as “reference width”) of a horizontal length (in the movement direction of the Y-axis moving stage) of the stationary stage 110 with respect to the movement direction of the X-axis moving stage 120.

If the radius of rotation is larger than the reference width, the first hinge shaft of the stationary stage 110 should be located at a lower end of the stationary stage 110 and the second hinge shaft 142 should be located at a lower end of the Y-axis moving stage 130. In addition, the thickness of each stage 120 or 130 is increased, so that the coupling force between the main body and the stationary stage 110 may be reduced.

In the meantime, the length of the compression spring 143 need not be the same as the radius of rotation, but is preferably determined within a range below the reference width in order to achieve effective linear movement of each stage 120 or 130.

As described above, in case of the elastic member of the conventional slide type terminal in which only X-axis or Y-axis linear movement is performed, there is only one critical point. However, there are four critical points at four points, at which a “+” shape defined by the lines extending in the X- and Y-axial directions with the first hinge shaft 141 as the center according to the movement of the X- and Y-axis moving stages 120 and 130 intersects with the circle of the radius of rotation, so that the elastic member 140 of this embodiment is axially rotated 360 degrees clockwise or counter-clockwise, as shown in FIG. 5. (In the present invention, the Y-axis moving stage is linearly moved only in the Y-axial direction, but can be rotated if the Y-axis moving stage cooperates with the X-axial linear movement of the X-axis moving stage. That is, the Y-axis moving stage is moved together with the second hinge shaft fixed to the center of the lower surface of the Y-axis moving stage.)

That is, when the Y-axis moving stage 130 is rotated in any one direction, the linear movement of the Y-axis moving stage 130 depends on user's force until reaching the critical point from the moment the Y-axis moving stage 130 begins to move, and depends on the elastic repulsive force of the elastic member 40 after passing by the critical point, so that a semi-automatic sliding movement can be achieved.

Therefore, according to the elastic member 140 in this embodiment, the linear movements of Up→Left→Down→Right (or Up→Right→Down→Left) and Left→Up→Right→Down (or Right→Up→Left→Down) can be freely selected. It is possible to solve the problem of the conventional two way sliding device in which the Y-axis (or X-axis) linear movement should be performed in advance for the X-axis (or Y-axis) linear movement.

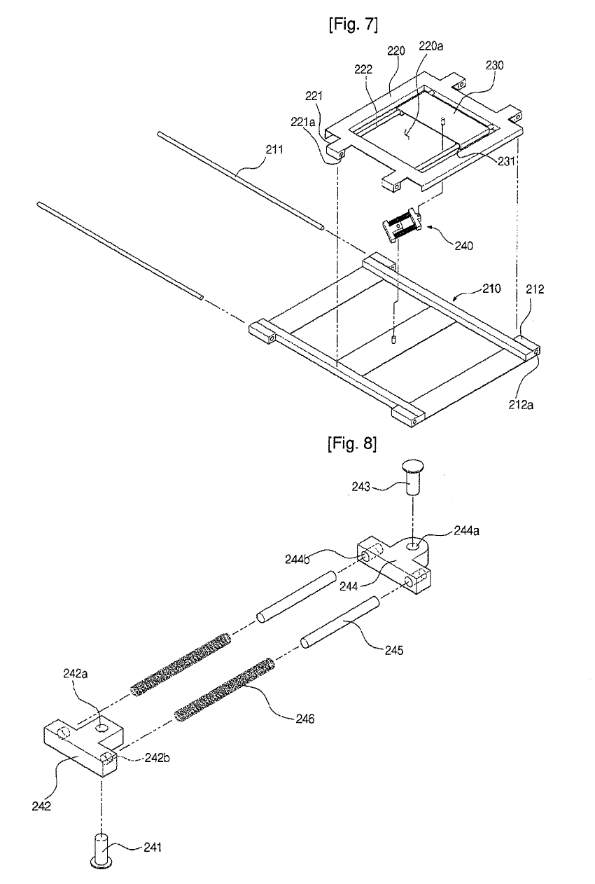

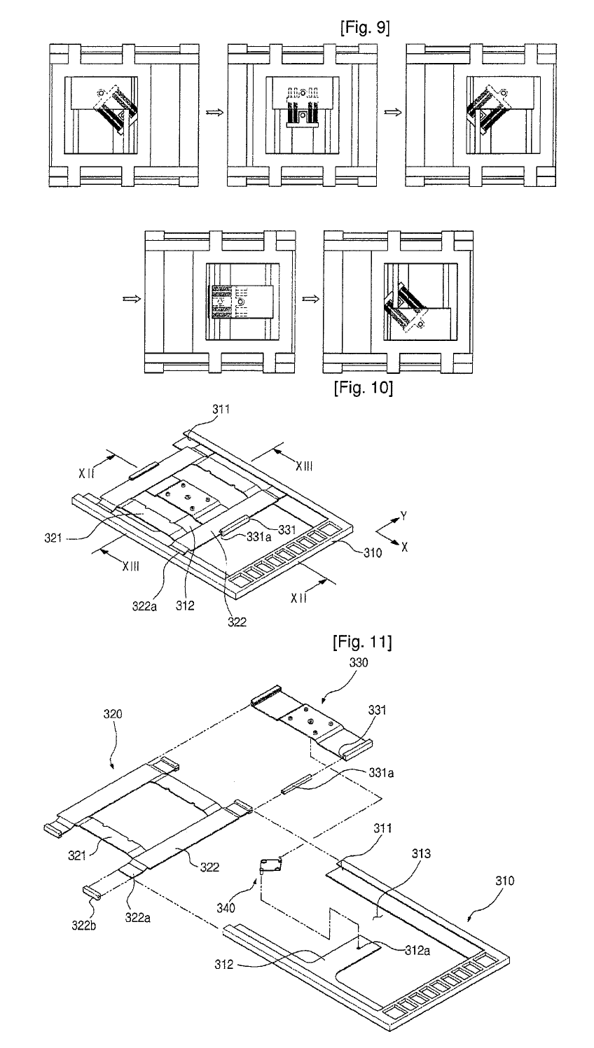

FIGS. 6 to 9 show a two way sliding device according to a second embodiment of the present invention.

A two way sliding device S according to the second embodiment comprises a stationary stage 210 fixed to a main body 1 provided with a key pad and the like; an X-axis moving stage 220 coupled to the stationary stage 210 and slid in an X-axial direction; and a Y-axis moving stage 230 fixed to a cover 2 provided with a liquid crystal display and slid in an Y-axial direction. The above configuration is substantially the same as that of the first embodiment.

At this time, horizontal cylindrical guide bars 211 acting as X-axial moving guide portions are provided at upper and lower sides of the stationary stage 210, respectively. Each of the guide bars 211 is coupled with a securing block 212, which is formed to protrude integrally with the stationary stage 210.

The X-axis moving stage 220 is the member slid on the stationary stage 210 in the horizontal direction. X-axis sliding portions 221 corresponding to the X-axial moving guide portions 211 are integrally formed at upper and lower sides of the X-axis moving stage. The X-axis sliding portion 221 includes a sliding block having an insertion hole 221a formed therein in the longitudinal direction so that the guide bar is inserted in the insertion hole.

In addition, an opening 220a is formed at the central portion of the X-axis moving stage 220. Guide bars 222, which function as Y-axial moving guide portions and are spaced apart from each other in the vertical direction, are provided in the opening 220a.

The Y-axis moving stage 230 is to move the cover on the X-axis moving stage 220 in the vertical direction. Y-axis sliding portions 231 are provided at both lateral sides of the Y-axis moving stage so that the Y-axial moving guide portions 222 of the X-axis moving stage 220 are inserted into and coupled with the Y-axis sliding portions, respectively. Like the X-axis sliding portion, each Y-axis sliding portion 231 includes a sliding block in which an insertion hole 231a is formed.

At this time, the securing block 212 protrudes upward from the stationary stage 210 to have the same thickness as the X-axis moving stage 220. The X-axis sliding portion is formed to extend and protrude downward from the X-axis moving stage 220 so as not to interfere with the stationary stage 210. In addition, the Y-axis sliding portions 231 formed under both the lateral sides of the Y-axis moving stage 230 has also the same thickness as the X-axis moving stage 220, so that the stationary stage 210, the X-axis moving stage 220 and the Y-axis moving stage 230 have the same thickness, whereby the sliding device has a one story structure.

In addition, like the first embodiment, the stationary stage 210 and the Y-axis moving stage 230 are elastically interconnected to each other through a single elastic member 240 for providing elastic force according to a change in movement of the Y-axis moving stage 230 to enable the X-axis moving stage or the Y-axis moving stage to operate semi-automatically.

Here, the elastic member 240 may have a structure different from the elastic member of the first embodiment. That is, as shown in FIG. 8, the elastic member comprises a first spring support 242 rotatably coupled with the stationary stage 210 by a first hinge shaft 241; a second spring support 244 rotatably coupled with the X-axis moving stage 220 by a second hinge shaft 243; cylindrical spring guides 245 connecting the first spring support 242 and the second spring support 244; and coil springs 246 winding around the spring guides 245 to provide elastic repulsive force by the first spring support 242 and the second spring support 244.

Each of the first and second spring supports 242 and 244 has an approximately “□” shape. The first spring support 242 is formed with recesses 242b in which the spring guides 245 can be seated. The second spring support 244 is formed with through holes 244b, through each of which an end of the spring guide 245 passes through by the elastic force of the coil spring 246 when the Y-axis moving stage 230 is axially rotated.

As in the first embodiment, the X- and Y-axial linear movements can be performed only by the single elastic member 240.

In FIG. 8, unexplained reference numerals “242a” and “244a” designate hinge holes, through which hinge shafts pass.

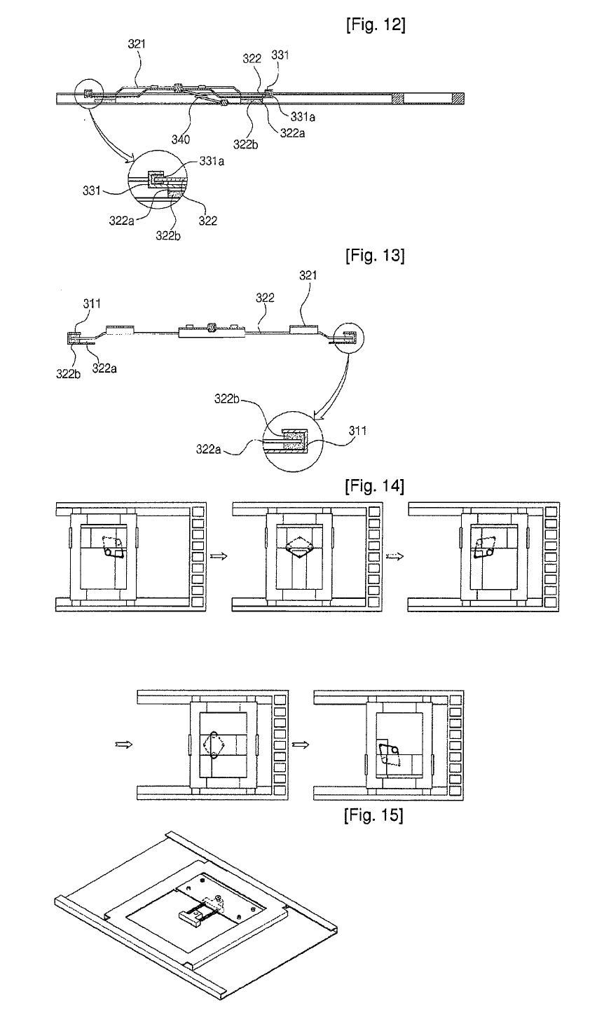

FIGS. 10 to 14 are views illustrating a two way sliding device according to a third embodiment of the present invention.

Similarly to the first embodiment, the two way sliding device according to this embodiment comprises a stationary stage 310 fixed to a main body provided with a key pad and the like; an X-axis moving stage 320 coupled to the stationary stage 310 and slid in the horizontal direction; a Y-axis moving stage 330 fixed to a cover provided with a liquid crystal display and slid in the vertical direction; and an elastic member 340 elastically interconnecting the stationary stage 310 and the Y-axis moving stage 330.

At this time, the stationary stage 310 in the first embodiment has a flat plate shape, but the stationary stage 310 in this embodiment is formed with an opening 314 and an elastic member coupling plate 312 extending in the vertical direction from the center in order to fix the elastic member 340. Due to the above configuration, it is possible to save the manufacturing cost and reduce the weight of the sliding device.

In addition, X-axial moving guide portions 311 are provided at upper and lower sides of the stationary stage 310. Each X-axial moving guide portion defines a “□”-shaped guide groove, which is bent upward and then extends inward the member.

The X-axis moving stage 320 includes a pair of horizontal supports 321 and a pair of vertical supports 322 coupled with the horizontal supports 321 perpendicularly thereto. That is, the pair of horizontal supports 321 are arranged at a certain interval and the vertical supports 322 are coupled with ends of the horizontal supports 321 perpendicularly thereto. Accordingly, an opening 320a is naturally defined at the center of the horizontal and vertical supports 321 and 322.

At this time, both ends of the horizontal support 321 are bent downward and both ends of the vertical support 322 are also bent downward, so that the X-axis moving stage 320 has an upward convex “cap” shape. Accordingly, a space in which the elastic member 340 is interposed is provided between the stationary stage 310 and the X-axis moving stage 320. In addition, X-axis sliding portions 322a extending outward are formed at ends of the vertical support 322 to be inserted into the “□”-shaped X-axial moving guide portions 311.

In order to wrap an outside portion of the vertical support 322, “□”-shaped Y-axis sliding portions 331 are formed at portions of both lateral sides of the Y-axis moving stage 330, which are bent downward and extend outward.

Accordingly, the elastic member 340 is positioned in the space defined between the elastic member coupling plate 312 and the Y-axis moving stage 330. As in the first embodiment, one end of the elastic member 340 is coupled to the center of the upper surface of the elastic member coupling plate 312 and the other end thereof is coupled to the center of the lower surface of the Y-axis moving stage 330.

As described above, the stationary stage 310, the X-axis moving stage 320 and the Y-axis moving stage 330 have a one story structure without a vertical displacement difference in the moving guide portions 311 and the sliding portions 322a and 331.

In the meantime, it is preferable that an assembling hole 313 is formed at one side of the elastic member coupling plate 312 in correspondence to the width of the Y-axis moving stage 330. That is, in a case where the assembling hole 313 is not formed, when the X-axis moving stage 320 with which the Y-axis moving stage 330 is coupled is assembled to the stationary stage 310, both ends of the Y-axis moving stage 330 are in contact with the elastic member coupling plate 312, so that a certain pressure should be applied to the Y-axis moving stage to assemble the X-axis moving stage 320 and the stationary stage 310 in the press-fit manner. However, in a case where the assembling hole 313 is formed, the Y-axis moving stage 330 is positioned corresponding to the assembling hole 313, and the X-axis sliding portions 322a of the X-axis moving stage 320 are then inserted into the X-axial moving guide portions 311 and slid, so that the assembling is naturally completed.

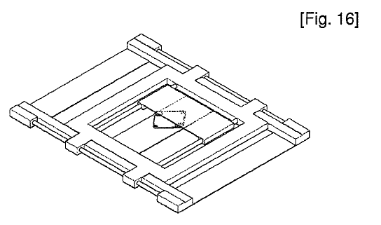

FIGS. 15 and 16 show modifications of the two way sliding device according to the present invention.

That is, the entire configuration of a two way sliding device of FIG. 15 is substantially the same as that of the first embodiment, and an elastic member is the same as that of the second embodiment.

The entire configuration of a two way sliding device of FIG. 16 is substantially the same as that of the second embodiment, and an elastic member is the same as that of the first embodiment.

That is, although the compression spring of the first embodiment or the coil spring in the third embodiment has been described as an example of the elastic member, the elastic member is not limited thereto. Any one of a compression spring, a tensile spring, a torsion spring and the like may be used as the elastic member if the elastic member satisfies the condition that one end is rotatably coupled to the stationary stage and the other end is rotatably coupled to the Y-axis moving stage.

1. A two way sliding device for a portable terminal in which a cover is slid with respect to a main body, the two way sliding device comprising:
a flat plate-shaped stationary stage fixed to the main body, the stationary stage having X-axial moving guide portions formed at upper and lower sides thereof in the vertical direction; an X-axis moving stage having X-axis sliding portions provided at upper and lower sides thereof in the horizontal direction to be coupled with the X-axial moving guide portions and moved in the horizontal direction, the X-axis moving stage having Y-axial moving guide portions provided at both lateral sides thereof in the vertical direction, the X-axis moving stage having an opening formed at a center thereof;
a Y-axis moving stage fixed to the cover, the Y-axis moving stage having Y-axis sliding portions formed at both lateral sides thereof to be coupled with the Y-axial moving guide portion and moved within the opening in the vertical direction; and
an elastic member having an end coupled with the stationary stage and the other end coupled with the Y-axis moving stage, thereby being rotated 360 degrees within a range of the opening when the slide of the X-axis moving stage in the horizontal direction and the slide of the Y-axis moving stage in the vertical direction cooperate with each other.

2. The two way sliding device as claimed in claim 1, wherein the X-axial moving guide portion is a “D”-shaped guide groove, which is bent upward from the X-axis moving stage and then extends inward, and the X-axis sliding portion is a sliding rail, which is bent downward from the X-axis moving stage and then extends outward.

3. The two way sliding device as claimed in claim 1, wherein the Y-axial moving guide portion has a shape, which is bent downward from the X-axis moving stage, and the Y-axis sliding portion is a “D”-shaped sliding rail, which is bent downward from the Y-axis moving stage and then extends outward, so that the Y-axis sliding portion is interposed between the stationary stage and the X-axis moving stage.

4. The two way sliding device as claimed in claim 1, wherein a guide member is coupled with one end of each of the sliding portions.

5. The two way sliding device as claimed in claim 4, wherein the guide member is made of a crude rubber or synthetic resin which can reduce friction.

6. The two way sliding device as claimed in claim 1, wherein the moving guide portion includes a guide bar, and the sliding portion includes a sliding block being slidable along the guide bar in a state where the guide bar is inserted in the sliding block.

7. The two way sliding device as claimed in claim 1, wherein the elastic member includes a first hinge axis rotatably coupled to the center of the stationary stage; a second hinge shaft rotatably coupled to the center of the Y-axis moving stage; and an elastic spring having one end coupled with the first hinge shaft and the other end coupled with the second hinge shaft.

8. The two way sliding device as claimed in claim 1, wherein the elastic member comprises a first spring support rotatably coupled with the stationary stage by a first hinge shaft; a second spring support rotatably coupled with the Y-axis moving stage by a second hinge shaft; a spring guide connecting the first spring support and the second spring support; and a coil spring winding around the spring guide and restricted by the first spring support and the second spring support.

9. The two way sliding device as claimed in claim 7, wherein the first hinge shaft is located at a point on an upper surface of the stationary stage at which an intermediate point of moving width of the X-axis moving stage meets an intermediate point of moving width of the Y-axis moving stage.

10. The two way sliding device as claimed in claim 7, wherein a radius of rotation of the elastic member does not exceed a half of a horizontal length of the stationary stage with respect to the movement direction of the X-axis moving stage.

11. A two way sliding device for a portable terminal in which a cover is slid with respect to a main body, the two way sliding device comprising: a stationary stage fixed to the main body, the stationary stage having X-axial moving guide portions formed at upper and lower sides thereof in the vertical direction, the stationary stage being provided with an elastic member coupling plate at a center thereof in the vertical direction; an X-axis moving stage having X-axis sliding portions provided at upper and lower sides thereof in the horizontal direction to be coupled with the X-axial moving guide portions and moved in the horizontal direction, the X-axis moving stage having Y-axial moving guide portions provided at both lateral sides thereof in the vertical direction, the X-axis moving stage having an opening formed at a center thereof; a Y-axis moving stage fixed to the cover, the Y-axis moving stage having Y-axis sliding portions formed at both lateral sides thereof to be coupled with the Y-axial moving guide portion and moved within the opening in the vertical direction; and an elastic member having an end coupled with the elastic member coupling plate and the other end coupled with the Y-axis moving stage, thereby being rotated 360 degrees within a range of the opening when the slide of the X-axis moving stage in the horizontal direction and the slide of the Y-axis moving stage in the vertical direction cooperate with each other.

12. The two way sliding device as claimed in claim 11, wherein an assembling hole corresponding to a width of the Y-axis moving stage is formed at one side of the elastic member coupling plate.

13. The two way sliding device as claimed in claim 11, wherein the X-axis moving stage includes a pair of horizontal supports arranged at a certain interval and a pair of vertical supports coupled with ends of the horizontal supports perpendicularly thereto to define an opening at the center of the horizontal and vertical supports, both ends of the horizontal support are bent downward, and both ends of the vertical support are bent downward to form the X-axis sliding portion extending outward.

14. The two way sliding device as claimed in claim 11, wherein a “D”-shaped Y-axis sliding portions are formed at portions of both lateral sides of the Y-axis moving stage, which are bent downward and extend outward, to wrap an outside portion of the X-axis moving stage.

15. The two way sliding device as claimed in claim 13, wherein a guide member is coupled with each of the sliding portions, the guide member being made of a crude rubber or synthetic resin which can reduce friction.
